(19) United States
(12) Patent Application Publication
(10) Pub. No.: US 2025/0222825 A1
(43) Pub. Date: Jul. 10, 2025

(54) USABLE ENERGY OPTIMIZATION FOR ELECTRIC VEHICLE

(71) Applicant: GM GLOBAL TECHNOLOGY OPERATIONS LLC, Detroit, MI (US)

(72) Inventors: Jun-mo Kang, Ann Arbor, MI (US); Su-Yang Shieh, Clawson, MI (US); Shuonan Xu, Troy, MI (US)

(73) Assignee: GM GLOBAL TECHNOLOGY OPERATIONS LLC, Detroit, MI (US)

(21) Appl. No.: 18/407,952

(22) Filed: Jan. 9, 2024

(51) Int. Cl. B60L 58/19; B60L 50/60; B60L 58/12; B60L 58/20

(52) U.S. Cl. CPC B60L 58/19; B60L 50/66; B60L 58/12; B60L 58/20; B60L 2200/10; B60L 2240/547; B60L 2260/44; B60L 2260/54

(57) ABSTRACT

Optimization of usable energy for an electric vertical takeoff and landing (eVTOL) or other electric vehicle. The optimization may include charging a low voltage (LV) energy source to meet energy demands of LV systems and loads onboard the vehicle prior to undertaking a landing operation, thereby optimizing usable energy of the vehicle by enabling the landing operation to occur independently of a high voltage (HV) energy source having to concurrently power the LV systems.

### INTRODUCTION

The present disclosure relates to optimizing usable energy for an electric vehicle, such as but not necessarily limited to optimizing usable energy available from a high voltage (HV) energy source of an electric vertical takeoff and landing (eVTOL) vehicle.

A wide range of electric vehicles may require a relatively significant amount of electrical energy to facilitate powering a propulsion system, with such electric vehicles generally operating in a manner whereby related current demands may fluctuate depending on activities being undertaken. In the case of an eVTOL vehicle, for example, the current demand may notably increase or approach maximum levels when undertaking takeoff or landing operations due to the attendant needs of a flight propulsion system to correspondingly consume proportional amounts of electrical energy from an electrical energy storage system. Electrical energy storage systems may be susceptible to performance fluctuations due to the effects of slower diffusion, diffusion congestion, and/or other influences resulting from the current demand. The performance fluctuations may be reflected by an amount in which a usable energy of the electrical energy storage system correspondingly deviates from its thermal-dynamical energy capacity. In the case of eVTOL vehicles or other electric vehicles whereby range, speed, duration, and other performance related parameters and capabilities may be dependent on having a sufficient supply of electrical energy to support relatively high current demanding activities, it may be beneficial to optimize the usable energy so that the maximum amount of electrical energy and performance may be achievable when needed.

### SUMMARY

One non-limiting aspect of the present disclosure relates to optimization of usable energy for an electrical energy storage system. The optimization may include predicting demands expected for a relatively high current activity and in advance thereof attempting to ameliorate at least a portion of the predict demands, such as by charging a low voltage (LV) energy source to meet predicted demand for LV systems in advance of a high voltage (HV) energy source being demanded to support the relatively high current activity. In the case of an electric vertical takeoff and landing (eVTOL) vehicle, the optimization may include predicting LV energy needed for the LV systems when undertaking a landing operation and in advance thereof charging the LV energy source to meet the predicted LV energy demand so that the landing operation may occur independently of the HV energy source having to concurrently power the LV systems. The energy available from LV energy source may also be used to provide energy to assist the HV energy source during the landing operation (or other high current activities), as the LV energy source may be used in this manner to as a source to provide large current in short period of time, e.g., ultra capacity.

One non-limiting aspect of the present disclosure relates to a method for optimizing usable energy of high voltage (HV) battery including onboard an electric vertical takeoff and landing (eVTOL) vehicle to electrically power a flight propulsion system. The method may include performing a low voltage (LV) energy prediction after the eVTOL vehicle completes a takeoff operation to estimate an expected LV energy consumption that LV systems onboard the eVTOL vehicle are expected to consume in performance of a landing operation, determining whether LV energy available from a LV battery onboard the eVTOL vehicle meets a LV landing threshold indicative of the LV battery possessing LV energy suitable for supplying an entirety of the expected LV energy consumption, implementing an assisted mode prior to commencement of the landing operation in response to the LV energy being unable to supply the entirety of the expected LV energy consumption, optionally with the assisted mode including use of the HV battery to facilitate charging the LV battery prior to commencement of the landing operation, and implementing an unassisted mode prior to commencement of the landing operation in response to the LV energy being able to supply the entirety of the expected LV energy consumption, optionally with the unassisted mode including powering the LV systems independently of the HV battery using the LV energy available from the LV battery so as to thereby optimize usable energy of the HV battery by enabling the landing operation to occur independently of the HV battery having to concurrently power the LV systems.

The method may include implementing the assisted mode to include using the HV battery to charge the LV battery to a charge level sufficient to meet the LV landing threshold.

The method may include implementing the assisted mode to include using the HV battery to power the LV systems while concurrently charging the LV battery.

The method may include performing a HV energy prediction after the eVTOL vehicle completes the takeoff operation, optionally with the HV energy prediction estimating an expected HV energy consumption the flight propulsion system is expected to consume in undertaking the landing operation.

The method may include determining whether HV energy available from the HV battery meets a HV landing threshold indicative of the HV battery possessing HV energy suitable for supplying an entirety of the expected HV energy consumption.

The method may include implementing the assisted mode to include charging the LV battery to a first charge level sufficient to meet the LV landing threshold in response to the HV energy being able to supply the entirety of the expected HV energy consumption and implementing the assisted mode to include charging the LV battery to a second charge level insufficient to meet the LV landing threshold in response to the HV energy being unable to supply the entirety of the expected HV energy consumption.

The method may include selecting the second charge level to be proportional to a difference between the HV energy and the HV landing threshold.

The method may include implementing a warmup mode prior to implementing the assisted and unassisted modes, optionally with the warmup mode powering the LV systems using HV energy provided from the HV battery so as to thereby optimize usable energy by warming the HV battery faster than a non-warmup mode.

The method may include the non-warmup mode including powering the LV systems using LV energy provided from the LV battery independently of the HV battery having to concurrently power the LV systems.

The method may include limiting implementation of the warmup mode to a beginning portion of a cruising operation, optionally with the beginning portion corresponding with a predetermined period of time occurring after the eVTOL vehicle reaches a cruising altitude following the takeoff operation.

The method may include selecting the predetermined period of time based on a length of time expected for a flight.

The method may include selecting the predetermined period of time to be proportional to a length of time expected for a flight.

The method may include the HV battery including a plurality of battery cells having a lithium-ion construction characterized by the battery cells experiencing slower diffusion and decreases in the usable energy when current demands are greater.

One non-limiting aspect of the present disclosure relates to a method for optimizing usable energy of high voltage (HV) energy source including onboard an electric vehicle to electrically power a propulsion system. The method may include determining whether low voltage (LV) energy available from a LV energy source onboard the electric vehicle meets a LV landing threshold indicative of the LV energy source possessing LV energy suitable for supplying an entirety of an expected LV energy consumption for undertaking a landing operation. The method may include implementing an assisted mode prior to commencement of the landing operation in response to the LV energy being unable to supply the entirety of the expected LV energy consumption, optionally with the assisted mode including charging of the LV energy source using HV energy provided from the HV energy source until the LV energy source is able to supply the entirety of the expected LV energy consumption so as to thereby optimize usable energy of the HV energy source by enabling the landing operation to occur independently of the HV energy source having to concurrently power the LV systems.

The method may include determining whether HV energy available from the HV energy source meets a HV landing threshold indicative of the HV energy source possessing HV energy suitable for supplying an entirety of an expected HV energy consumption for undertaking the landing operation.

The method may include suspending the assisted mode to prevent further use of the HV energy source in charging the LV energy source in response to the HV energy being unable to supply the entirety of the expected HV energy consumption.

The method may include the HV energy source including a plurality of battery cells having a lithium-ion construction characterized by the battery cells experiencing diffusion fluctuations in proportion to current demands thereon.

The method may include determining the expected HV energy consumption based at least in part on an expected amount of diffusion predicted to occur at a terminal of the HV energy source while undertaking the landing operation.

One non-limiting aspect of the present disclosure relates to a system for optimizing usable energy of an electric vehicle. The electric vehicle may include an electric propulsion system configured for converting high voltage (HV) energy to mechanical energy suitable for use in propelling the electric vehicle and a low voltage (LV) bus configured for distributing LV energy for one or more LV systems onboard the electric vehicle. The system may include a rechargeable energy storage system (RESS) configured for providing the HV energy to the electric propulsion system and the LV energy to the LV bus, the RESS including a plurality of energy cells configured for storing and supplying electrical energy and a usable energy controller. The useable energy controller may be configured for determining whether low voltage (LV) energy available from a LV energy source connected to the LV bus meets a LV landing threshold indicative of the LV energy source possessing LV energy suitable for supplying an entirety of an expected LV energy consumption for undertaking a landing operation, implementing an assisted mode prior to commencement of the landing operation in response to the LV energy being unable to supply the entirety of the expected LV energy consumption, optionally with the assisted mode including charging of the LV energy source using HV energy provided from the RESS until the LV energy source is able to supply the entirety of the expected LV energy consumption, and implementing an unassisted mode prior to commencement of the landing operation in response to the LV energy being able to supply the entirety of the expected LV energy consumption, optionally with the unassisted mode including reliance on the LV energy source to power the LV systems independently of the RESS.

The usable energy controller may be configured for implementing a warmup mode prior to implementing the assisted and the unassisted mode, optionally with the warmup mode powering the LV systems using HV energy provided from the RESS to thereby optimize usable energy by warming a HV energy source of the RESS faster than if the LV systems were powered independently of the HV energy source.

The HV energy source may include a plurality of battery cells having a lithium-ion construction.

These features and advantages, along with other features and advantages of the present teachings, may be readily apparent from the following detailed description of the modes for carrying out the present teachings when taken in connection with the accompanying drawings. It should be understood that even though the following figures and embodiments may be separately described, single features thereof may be combined to additional embodiments.

### BRIEF DESCRIPTION OF THE DRAWINGS

The accompanying drawings, which may be incorporated into and constitute a part of this specification, illustrate implementations of the disclosure and together with the description, serve to explain the principles of the disclosure.

FIG. 1 illustrates a schematic view of a vehicle configured for optimizing usable energy in accordance with one non-limiting aspect of the present disclosure.

FIG. 2 illustrates a flowchart of a method for optimizing usable energy in accordance with one non-limiting aspect of the present disclosure.

### DETAILED DESCRIPTION

As required, detailed embodiments of the present disclosure may be disclosed herein; however, it may be understood that the disclosed embodiments may be merely exemplary of the disclosure that may be embodied in various and alternative forms. The figures may not be necessarily to scale; some features may be exaggerated or minimized to show details of particular components. Therefore, specific structural and functional details disclosed herein may need not to be interpreted as limiting, but merely as a representative basis for teaching one skilled in the art to variously employ the present disclosure.

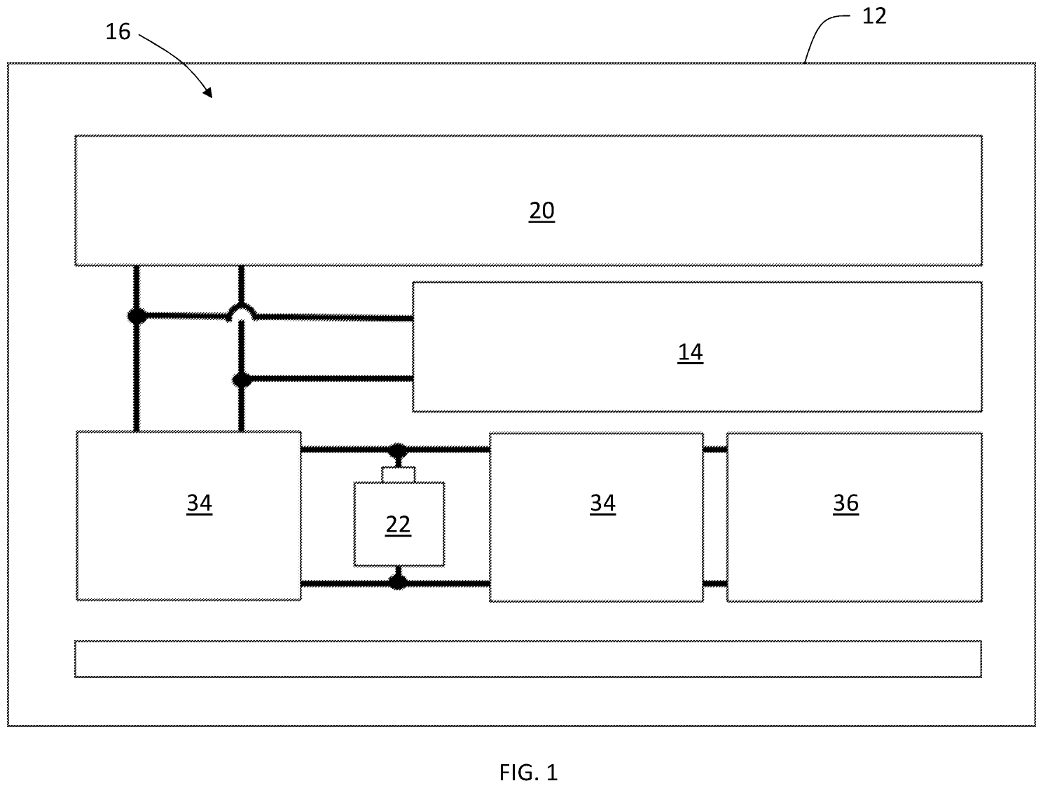

FIG. 1 illustrates a schematic view of a vehicle 12 configured for optimizing usable energy in accordance with one non-limiting aspect of the present disclosure. The vehicle 12 is predominately described with respect to being configured as a type of electric vertical takeoff and landing (eVTOL) vehicle 12 capable of taking flight. The vehicle 12 may include a propulsion system 14 configured for converting electrical energy to mechanical energy operable for purposes of generating thrust, lift, or other forces sufficient for performing vertical takeoff and landing operations. The propulsion system 14, while not shown separately, may include an electric motor operable with a drivetrain or other mechanical system operable for generating thrust sufficient for lifting the vehicle 12 off the ground as part of a takeoff operation, propelling the vehicle 12 through the air as part of a cruising operation, and thereafter landing the vehicle 12 on the ground as part of a landing operation. The vehicle 12, and in particular the propulsion system 14, may be configured to facilitate flights generally associated with drones, helicopters, airplanes, and/or other machines capable of aerial flight. The vehicle 12 is presented for exemplary purposes as representative of a wide range of electric vehicles where current demands of the propulsion system 14 may notably increase or approach maximum levels when undertaking certain activities, such as the takeoff or landing operations, due to the attendant needs of the propulsion system 14 to correspondingly consume proportional amounts of electrical energy. This is done for non-limiting purpose as the present disclosure fully contemplates its use and application with other types of vehicles that may be benefit from optimizing usable energy in the manner described herein, including electric trucks or equipment that may utilize the propulsion system 14 for ground or non-aerial movement or work.

The vehicle 12 may include a rechargeable energy storage system (RESS) 16 configured for storing and supplying electrical energy. The RESS 16 may include a variety of components configured for storing and supplying electrical energy, which in the exemplary illustration may include a first energy source 20 and a second energy source 22. The first energy source may be considered as a high voltage (HV) energy source operable for storing and supplying HV energy and the second energy source may be considered as a separate, low voltage (LV) energy source operable for storing and supplying LV energy. The HV and LV energy sources 20, 22 may respectively include one or more battery cells (not shown), optionally with the battery cells arranged into one or more modules (not shown). To HV energy source 20 may include more and/or higher battery cells and/or modules than the LV energy source 22, optionally with the battery cells/modules thereof connected in a particular manner such that the HV energy source 20 is capable of storing supplying electrical energy at relatively greater levels than the LV energy source 22. The battery cells may be comprised of a wide variety of components operable for storing and supplying electrical power. The battery cells, for example, may include a lithium-ion material or other material chemistry suitable for storing and supplying electrical power, optionally with some of the battery cells having mixed or different chemistries than some of the other battery cells. The use of battery cells, however, are presented for non-limiting purposes as the present disclosure fully contemplates the battery cells being other types of energy cells capable of storing and/or supplying electrical power, such as but not necessarily limited to energy cells comprised partially or entirely of capacitors, supercapacitors, fuel cells, and/or other types of energy components.

The RESS 16 may optionally include a converter 26 connected between the HV and LV energy sources 20, 22, such as via a HV or main bus 28 connected to the HV energy source 20 and the propulsion system 14 and a LV or auxiliary bus 30 connected to the LV energy source 22 and one or more LV systems 32. The LV systems 32 may include a number of different systems and is shown for non-limiting purpose to include an auxiliary power unit 34 operable for powering accessories, heating ventilation and air conditioning (HVAC) and/or other auxiliary systems 36. The converter 26 may be configured for converting electrical energy for distribution between the HV and/or LV buses 28, 30. The converter 26, for example, may be a direct current (DC) to DC (DC-DC) converter 26 or other suitable converter 26 operable for converting HV energy available from the HV energy source 20 for use over the LV bus 30 and/or for converting LV energy available from the LV energy source 22 for use over the HV bus 28. The converter 26 is presented for non-limiting purposes as representative of various systems that may be employed to facilitate managing electrical energy distribution between multiple energy sources onboard the vehicle 12. The vehicle 12 may include a controller 40 to facilitate monitoring, controlling, measuring, and otherwise directing operation, performance, etc. onboard the vehicle 12, which may include performing measurements, taking readings, or otherwise collecting data to facilitate operations. The controller 40 may include additional controllers (not shown), with the operations associated therewith optionally being undertaken according to one or more processors executing corresponding non-transitory instructions stored one or more computer-readable storage mediums.

The RESS 16 may be susceptible to performance fluctuations due to the effects of slower diffusion, diffusion congestion, and/or other influences resulting from current demands placed upon the HV and LV energy sources 20, 22 during vehicle 12 operation. The diffusion, for example, may relate to a surface density of a terminal, e.g., an anode lithium surface, of the HV energy source 20 decreasing such that a maximum terminal voltage possible thereat correspondingly decreases to thereby limit available power. The resulting performance fluctuations may be relatively more pronounced for the HV energy source 20 than the LV energy source 22 due to the comparatively greater current demands of the propulsion system 14 relative to the LV systems 32. For the sake of presentation simplicity, the present disclosure is predominately described with respect to optimizing usable energy of the HV energy source 20 so as to maximize its performance and/or to limit performance fluctuations, which may be particularly beneficial in improving performance, flight range, longevity, efficiency, etc. for the propulsion system 14. The performance fluctuations may be reflected in an amount by which a usable energy of the HV energy source 20 at a given point in time deviates from its thermal-dynamical energy capacity. The thermal-dynamical energy capacity may be a representation of a maximum or theoretical amount of electrical energy available from the HV energy source 20 under ideal or design conditions. The usable energy, in contrast, may be a representation of an operational amount of electrical energy actually available from the HV energy source 20 given the presently occurring operating conditions, environment, etc.

In the case of eVTOL vehicles or other electric vehicles whereby range, speed, duration, and other performance related parameters and capabilities may be dependent on having a sufficient supply of electrical energy to support relatively high current demanding activities, it may be beneficial to optimize the usable energy of the HV energy source 20 so that the maximum amount of electrical energy and performance may be achievable when needed. One non-limiting aspect of the present disclosure relates to the controller 40 being or including a usable energy controller 40 operable for optimizing usable energy for the HV energy source 20. The related optimization may include predicting demands expected for a relatively high current activity and in advance thereof attempting to ameliorate at least a portion of the predict demands, such as by charging the LV energy source 22 to meet predicted demand for LV systems 32 in advance of the HV energy source 20 being demanded to support a relatively high current activity. In the case of an electric vertical takeoff and landing (eVTOL) vehicle 12, for example, the optimization may include predicting LV energy needed for the LV systems 32 when undertaking a landing operation and in advance thereof charging the LV energy source 22 to meet the predicted LV energy demand so that the landing operation may occur independently of the HV energy source 20 having to concurrently power the LV systems 32.

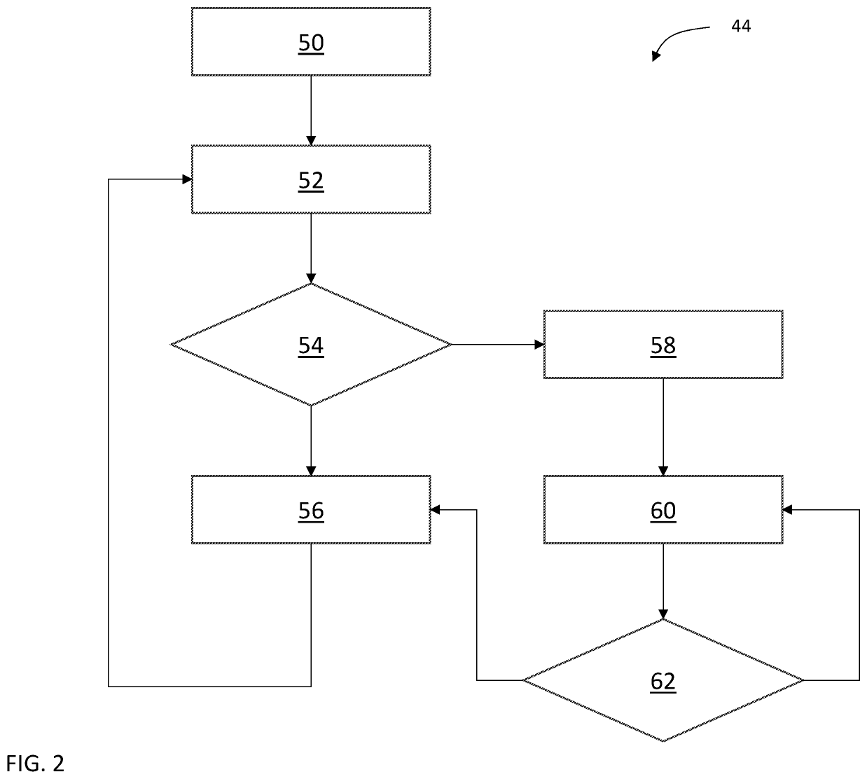

FIG. 2 illustrates a flowchart 44 of a method for optimizing usable energy in accordance with one non-limiting aspect of the present disclosure. The method is predominately described with respect to optimizing usable energy for the HV energy source 20 included within the vehicle 12, however, as one skilled in the art may appreciate, the contemplated optimization may be beneficial with other types of energy sources, including but not necessarily limited to non-HV energy sources and/or energy sources included in other types of vehicles. The method may be implemented according to various systems, processes, controls, etc., and is described for non-limiting purposes with respect to the controller 40 being or including a usable energy controller 40 operable according to one or more processors associated therewith executing a corresponding plurality of non-transitory instructions stored on one or more computer-readable storage mediums.

Block 50 relates to the controller 40 implementing a warmup mode after the vehicle 12 completes a takeoff operation or is otherwise engaging in a suitable operating activity. The warmup mode may begin after the propulsion system 14 has consumed electrical energy from the HV energy source 20 to lift the vehicle 12 off the ground to commence a cruising operation whereupon it may be desirable for the vehicle 12 to perform a flight from one location to another, hover over a particular location, or otherwise engaging in aerial operations. The warmup mode may include powering the LV systems 32 using HV energy provided from the HV energy source 20, i.e., via the converter 26, to optimize usable energy by warming the HV energy source 20 faster than if the LV systems 32 were powered independently of the HV energy source 20. The warmup mode may be contrasted with a non-warmup or standard mode whereby the LV systems 32 may be powered using LV energy provide from the LV energy source 22 independently of the HV energy source 20, i.e., without requiring the converter 26 to convert HV energy for use over the LV boss. The warmup mode may optionally be limited to a beginning portion of the cruising operation corresponding with a predetermined period of time occurring after the vehicle 12 reaches a cruising altitude or other suitable sate following the takeoff operation. The predetermined period of time may be based on a length of time expected for a flight and/or proportional to a length of time expected for the flight such that the predetermined period of time may be longer when the length of time is longer and shorter when the length of time is shorter.

Block 52 relates to the controller 40 making an LV energy prediction as part of a LV prediction process. The LV prediction process is shown to occur after the warm-up mode for non-limiting purposes as the warmup mode may be omitted altogether, skipped in the event a flight is too short, or the warm-up process may occur simultaneously in concert with the LV prediction process. One non-limiting aspect of the present disclosure contemplates the LV prediction process being an iterative or ongoing process whereby the controller 40 may make the predictions contemplated herein repeatedly throughout a flight so as to optimize usable energy for the HV energy source 20 prior to commencing a landing operation. The LV prediction process may include estimating an expected LV energy consumption that the LV systems 32 may be expected to consume while a landing operation is ongoing.

Block 54 relates to an LV assessment process whereby the controller 40 may determine whether the LV energy currently available from the LV energy source 22 is sufficient to meet a LV landing threshold indicative of the LV energy source 22 possessing LV energy suitable for supplying an entirety of the expected LV energy consumption. The LV energy source 22 may be considered to include sufficient LV energy if it is operable to meet the demand without requiring use of the converter 26 to convert HV energy provided from the HV energy source 20. The LV landing threshold may be a variable that changes throughout the flight and/or that varies from one type of vehicle 12 to another. The LV landing threshold, as such, may increase or decrease during the flight, optionally in response to changes in wind condition, altitude, moisture, etc., and/or depending on capabilities of the vehicle 12 and/or the propulsion system 14. The LV landing threshold may optionally relate to a minimum amount of LV energy needed to operate less than each of system LV systems 32, e.g., a minimum subset needed to properly or desirably land the vehicle 12. The LV landing threshold may thereby correspond with a minimum amount of LV energy needed at a given point in flight or time should the vehicle 12 immediately or contemporaneously thereto commence a landing operation.

Block 56 relates to implementing an unassisted mode prior to commencement of the landing operation in response to the LV energy being able to supply the entirety of the expected LV energy consumption. The unassisted mode may include powering the LV systems 32 independently of the HV battery using the LV energy available from the LV battery. The limitation of using LV energy from the LV energy source 22 during the unassisted mode may correspondingly optimize usable energy of the HV battery by enabling the landing operation to occur independently of the HV battery having to concurrently power the LV systems 32. The capability to prevent concurrent use of the HV energy source 20 to power the LV systems 32 during the landing operation may reduce the current demands placed upon the HV energy system such that the amount of diffusion occurring at a terminal of the HV energy source 20 during the landing operation may be reduced relative to situations whereby the HV energy system may be required to concurrently power the LV systems 32 during landing. The feasibility of the unassisted mode may be reassessed at an ongoing basis throughout the flight to continuously determine whether a sufficient amount of LV energy is available from the LV energy source 22 to meet the expected LV energy consumption should the vehicle 12 thereafter commence a landing operation.

Block 58 relates to the controller 40 making an HV energy prediction as part of a HV prediction process. The prediction process is shown to occur after the LV prediction process for non-limiting purposes as the HV prediction process may be an ongoing process that may occur simultaneously in concert with the LV prediction. One non-limiting aspect of the present disclosure contemplates the HV prediction process being an iterative or ongoing process whereby the controller 40 may make the predictions contemplated herein repeatedly throughout a flight so as to optimize usable energy for the HV energy source 20 prior to commencing a landing operation. The HV prediction process may include estimating an expected HV energy consumption that the HV systems may be expected to consume in performance of a landing operation, i.e., the HV energy the propulsion system 14 or other HV dependent systems may need to facilitate landing the vehicle 12. The HV prediction process may include determining whether the HV energy currently available from the HV energy source 20 is sufficient to meet a HV landing threshold indicative of the HV energy source 20 possessing HV energy suitable for supplying an entirety of the expected HV energy consumption. The HV landing threshold may optionally be based at least in part on an expected amount of diffusion predicted to occur at a terminal of the HV energy source 20 while undertaking the landing operation. The HV landing threshold, like the LV threshold, may be a variable that changes throughout the flight and/or that varies from one type of vehicle 12 to another. The HV landing threshold may thereby correspond with a minimum amount of HV energy needed at a given point in flight or time should the vehicle 12 immediately or contemporaneously thereto commence a landing operation.

Block 60 relates to implementing an assisted mode prior to commencement of the landing operation in response to the LV energy being unable to supply the entirety of the expected LV energy consumption. The assisted mode may include use of the HV battery to facilitate charging the LV battery prior to commencement of the landing operation, which may include, charging the LV battery to a first charge level sufficient to meet the LV landing threshold in response to the HV energy being able to supply the entirety of the expected HV energy consumption and charging the LV battery to a second charge level insufficient to meet the LV landing threshold in response to the HV energy being unable to supply the entirety of the expected HV energy consumption. The second charge level may be selected to be proportional to a difference between the HV energy and the HV landing threshold, i.e., the second charge level may be greater when the difference is less and less when the difference is greater. In other words, the second charge level may correspond with a maximum at which the HV energy source 20 may be able to charge the LV energy source 22 while still maintaining capabilities for landing the vehicle 12 within desirable acceptable landing parameters or requirements. The assisted mode may optionally include decreasing a flight duration or otherwise taking corrective action so that the HV energy source 20 may be used to fully charge the LV battery as much as reasonable to meet the expected LV energy consumption for a landing operation.

Block 62 relates to a maintenance process whereby the charging of the LV energy source 22 using the HV energy source 20 may continue throughout the flight, i.e., it may be an ongoing process whereby the HV energy source 20 is used to periodically charge the LV energy source 22 during the flight. The charging may be iteratively implementing by repetitively using the HV energy source 20 to charge the LV energy source 22 each time the LV energy source 22 drops below the LV landing threshold while the HV energy source 20 possesses sufficient reserves for meeting the HV landing threshold. This charging of the LV energy source 22 may optionally be supplemented with regenerative systems (not shown) included onboard the vehicle 12 concurrently generating electrical energy sufficient for providing additional energy for powering charging the LV and/or HV energy sources 20, 22. The charging may continue until the LV energy source 22 is sufficiently charged to meet the LV landing threshold or the HV energy source 20 is no longer able to keep charging the LV energy source 22 while maintaining acceptable energy reserves for powering the propulsion system 14 is required for the landing operation, which for exemplary purposes is shown to include reverting to the unassisted mode in Block. This capability to charge the LV energy source 22 prior to commencement of high current demands upon the LV energy source 22 may reduce diffusion and thereby optimize usable energy due to the current demands on the HV energy source 20 potentially being reduced during landing and other high current activities by enabling those activities to occur independently of the HV energy source 20 having to concurrently power LV systems 32.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims. Although several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed is:

1. A method for optimizing usable energy of a high voltage (HV) battery including onboard an electric vertical takeoff and landing (eVTOL) vehicle to electrically power a flight propulsion system, comprising:
performing a low voltage (LV) energy prediction after the eVTOL vehicle completes a takeoff operation, the LV energy prediction estimating an expected LV energy consumption that LV systems onboard the eVTOL vehicle are expected to consume in performance of a landing operation;
determining whether LV energy available from a LV battery onboard the e VTOL vehicle meets a LV landing threshold indicative of the LV battery possessing LV energy suitable for supplying an entirety of the expected LV energy consumption;
implementing an assisted mode prior to commencement of the landing operation in response to the LV energy being unable to supply the entirety of the expected LV energy consumption, the assisted mode including use of the HV battery to facilitate charging the LV battery prior to commencement of the landing operation; and
implementing an unassisted mode prior to commencement of the landing operation in response to the LV energy being able to supply the entirety of the expected LV energy consumption, the unassisted mode including powering the LV systems independently of the HV battery using the LV energy available from the LV battery, thereby optimizing usable energy of the HV battery by enabling the landing operation to occur independently of the HV battery having to concurrently power the LV systems.

2. The method according to claim 1, further comprising:
implementing the assisted mode to include using the HV battery to charge the LV battery to a charge level sufficient to meet the LV landing threshold.

3. The method according to claim 2, further comprising:
implementing the assisted mode to include using the HV battery to power the LV systems while concurrently charging the LV battery.

4. The method according to claim 1, further comprising:
performing a HV energy prediction after the eVTOL vehicle completes the takeoff operation, the HV energy prediction estimating an expected HV energy consumption the flight propulsion system is expected to consume in undertaking the landing operation.

5. The method according to claim 4, further comprising:
determining whether HV energy available from the HV battery meets a HV landing threshold indicative of the HV battery possessing HV energy suitable for supplying an entirety of the expected HV energy consumption.

6. The method according to claim 5, further comprising:
implementing the assisted mode to include charging the LV battery to a first charge level sufficient to meet the LV landing threshold in response to the HV energy being able to supply the entirety of the expected HV energy consumption; and
implementing the assisted mode to include charging the LV battery to a second charge level insufficient to meet the LV landing threshold in response to the HV energy being unable to supply the entirety of the expected HV energy consumption.

7. The method according to claim 6, further comprising:
selecting the second charge level to be proportional to a difference between the HV energy and the HV landing threshold.

8. The method according to claim 1, further comprising:
implementing a warmup mode prior to implementing the assisted and unassisted modes, the warmup mode powering the LV systems using HV energy provided from the HV battery, thereby optimizing usable energy by warming the HV battery faster than a non-warmup mode.

9. The method according to claim 8, further comprising:
the non-warmup mode including powering the LV systems using LV energy provided from the LV battery independently of the HV battery having to concurrently power the LV systems.

10. The method according to claim 8, further comprising:
limiting implementation of the warmup mode to a beginning portion of a cruising operation, the beginning portion corresponding with a predetermined period of time occurring after the eVTOL vehicle reaches a cruising altitude following the takeoff operation.

11. The method according to claim 10, further comprising:
selecting the predetermined period of time based on a length of time expected for a flight.

12. The method according to claim 10, further comprising:
selecting the predetermined period of time to be proportional to a length of time expected for a flight.

13. The method according to claim 1, further comprising:
the HV battery including a plurality of battery cells having a lithium-ion construction characterized by the battery cells experiencing slower diffusion and decreases in the usable energy when current demands are greater.

14. A method for optimizing usable energy of high voltage (HV) energy source including onboard an electric vehicle to electrically power a propulsion system, comprising:
determining whether low voltage (LV) energy available from a LV energy source onboard the electric vehicle meets a LV landing threshold indicative of the LV energy source possessing LV energy suitable for supplying an entirety of an expected LV energy consumption for undertaking a landing operation; and
implementing an assisted mode prior to commencement of the landing operation in response to the LV energy being unable to supply the entirety of the expected LV energy consumption, the assisted mode including charging of the LV energy source using HV energy provided from the HV energy source until the LV energy source is able to supply the entirety of the expected LV energy consumption, thereby optimizing usable energy of the HV energy source by enabling the landing operation to occur independently of the HV energy source having to concurrently power the LV systems.

15. The method according to claim 14, further comprising:
determining whether HV energy available from the HV energy source meets a HV landing threshold indicative of the HV energy source possessing HV energy suitable for supplying an entirety of an expected HV energy consumption for undertaking the landing operation.

16. The method according to claim 15, further comprising:
suspending the assisted mode to prevent further use of the HV energy source in charging the LV energy source in response to the HV energy being unable to supply the entirety of the expected HV energy consumption.

17. The method according to claim 16, further comprising:
the HV energy source including a plurality of battery cells having a lithium-ion construction characterized by the battery cells experiencing diffusion fluctuations in proportion to current demands thereon.

18. The method according to claim 17, further comprising:
determining the expected HV energy consumption based at least in part on an expected amount of diffusion predicted to occur at a terminal of the HV energy source while undertaking the landing operation.

19. A system for optimizing usable energy of an electric vehicle, the electric vehicle including an electric propulsion system configured for converting high voltage (HV) energy to mechanical energy suitable for use in propelling the electric vehicle and a low voltage (LV) bus configured for distributing LV energy for one or more LV systems onboard the electric vehicle, the system comprising:
a rechargeable energy storage system (RESS) configured for providing the HV energy to the electric propulsion system and the LV energy to the LV bus, the RESS including a plurality of energy cells configured for storing and supplying electrical energy; and
a usable energy controller configured for:
determining whether low voltage (LV) energy available from a LV energy source connected to the LV bus meets a LV landing threshold indicative of the LV energy source possessing LV energy suitable for supplying an entirety of an expected LV energy consumption for undertaking a landing operation;
implementing an assisted mode prior to commencement of the landing operation in response to the LV energy being unable to supply the entirety of the expected LV energy consumption, the assisted mode including charging of the LV energy source using HV energy provided from the RESS until the LV energy source is able to supply the entirety of the expected LV energy consumption; and
implementing an unassisted mode prior to commencement of the landing operation in response to the LV energy being able to supply the entirety of the expected LV energy consumption, the unassisted mode including reliance on the LV energy source to power the LV systems independently of the RESS.

20. The system according to claim 19, wherein:
the usable energy controller is configured for implementing a warmup mode prior to implementing the assisted and the unassisted mode, the warmup mode powering the LV systems using HV energy provided from the RESS to thereby optimize usable energy by warming a HV energy source of the RESS faster than if the LV systems were powered independently of the HV energy source; and
the HV energy source includes a plurality of battery cells having a lithium-ion construction.
